(19) United States
(12) Patent Application Publication
(10) Pub. No.: US 2009/0133050 A1
(43) Pub. Date: May 21, 2009

(54) METHODS FOR PROVIDING PREVIEWS AND SYSTEMS THEREOF

(76) Inventor: Anastasia Kelly, New York, NY (US)

Correspondence Address: NIXON PEABODY LLP - PATENT GROUP, 1100 CLINTON SQUARE, ROCHESTER, NY, 14604, US

(21) Appl. No.: 12/243,593

(22) Filed: Oct. 1, 2008

Related U.S. Application Data
(60) Provisional application No. 60/960,452, filed on Oct. 1, 2007.

(51) Int. Cl. H04N 7/16; G06F 13/00

(52) U.S. Cl. 725/28; 725/61

(57) ABSTRACT

A method, computer readable medium, and system that provides previews includes providing one or more previews for selection by a mobile communication system. A selection of one or more of the provided previews is received from the mobile communication system and the selected one or more previews are provided to the mobile communication system for playing.

This application claims the benefit of U.S. Provisional Patent Application Ser. No. 60/960,452, filed Oct. 1, 2007, which is herein incorporated by reference in its entirety.

### FIELD

The present invention generally relates to methods and systems for providing previews and, more particularly, to methods for providing previews on mobile communication systems and systems thereof.

### BACKGROUND

The volume and types of entertainment options being offered to consumers continues to escalate. Before making a decision on one of these entertainment decisions, consumers often desire to access and view previews about their entertainment options. Unfortunately, consumers do not always have ready access to computer systems which can provide these previews to the consumers. For example, a consumer may be out and decide at the last minute they would like to watch a movie, but are not familiar with the current releases and would like to see previews of one or more of the current releases before making a decision on which movie to see.

### SUMMARY

A method for providing previews in accordance with embodiments of the present invention includes providing one or more previews for selection by a mobile communication system. A selection of one or more of the provided previews is received from the mobile communication system and the selected one or more previews are provided to the mobile communication system for viewing.

A computer readable medium having stored thereon instructions for providing previews comprising machine executable code which when executed by at least one processor in accordance with other embodiments of the present invention includes, causes the processor to perform steps including providing one or more previews for selection by a mobile communication system. A selection of one or more of the provided previews is received from the mobile communication system and the selected one or more previews are provided to the mobile communication system for playing.

A system for providing previews in accordance with embodiments of the present invention includes a preview listing system, a preview processing system, and a preview distribution system. The preview listing system provides one or more previews for selection by a mobile communication system. The preview processing system receives a selection of one or more of the provided previews from the mobile communication system. The preview distribution system provides the selected one or more previews for playing to the mobile communication system

The present invention provide a number of advantages including providing an easy to use and effective method and system to preview content, such as for a movie, DVD, TV show, game, commercial, user generated content, and IPTV, whenever and where ever the consumer wants on a mobile communication system. Additionally, the present invention provides consumers with another form of entertainment on mobile communication systems. Further, the opt-in aspect of the present invention allows for more directed marketing of products and services. Even further, the present invention is able to provide and process immediate theater selections and movie ticket purchase along with purchase options for DVDs, games, and other products and services resulting from watching the previews.

### BRIEF DESCRIPTION OF THE DRAWINGS

FIG. 1 is a block diagram of a system that provides previews in accordance with embodiments of the present invention;

FIG. 2 is a flowchart of a method for selecting a category of previews to view in accordance with embodiments of the present invention;

FIG. 3 is a flowchart of a method for providing movie previews in accordance with embodiments of the present invention;

FIG. 4 is a flowchart of a method for providing DVD previews in accordance with embodiments of the present invention;

FIG. 5 is a flowchart of a method for providing television show previews in accordance with embodiments of the present invention;

FIG. 6 is a flowchart of a method for providing game previews in accordance with embodiments of the present invention;

FIG. 7 is a flowchart of a method for providing commercial previews in accordance with embodiments of the present invention;

FIG. 8 is a flowchart of a method for providing user generated content previews in accordance with embodiments of the present invention; and

FIG. 9 is a flowchart of a method for providing mobile preview content for Internet protocol television (IPTV) show previews in accordance with embodiments of the present invention.

### DETAILED DESCRIPTION

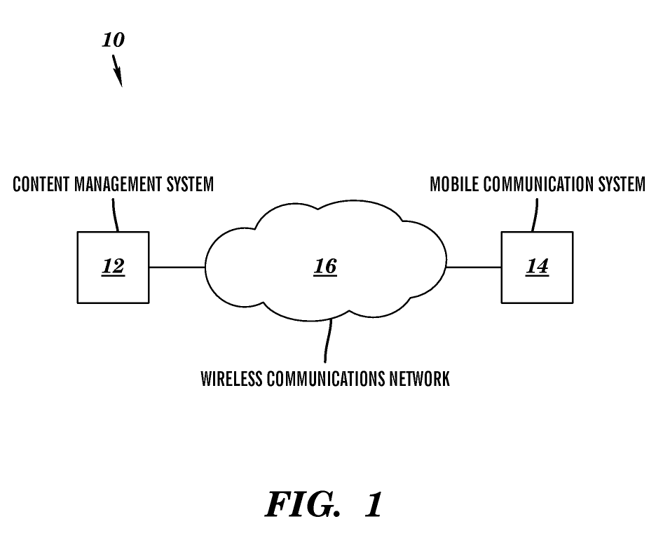

A system 10 that provides previews in accordance with embodiments of the present invention is illustrated in FIG. 1. The system 10 includes a content management system 12 and a mobile communication system 14, although the system 10 can include other types and numbers of components, devices, systems and/or servers configured in other manners, such as having content management systems and multiple mobile communication systems. The present invention provides a number of advantages including providing an easy to use and effective method and system to preview content, such as for a movie, DVD, TV show, game, commercial, user generated content, and IPTV, whenever and where ever the consumer wants on a mobile communication system.

Referring to FIG. 1, the content management system 12 manages and transmits movie, television, video game trailers and other content to consumers through their mobile communication system 14, although other types and numbers of computing systems, in other locations, with other capabilities and functions could be used. The content management system 12 includes a central processing unit (CPU) or processor, a memory, and an interface system which are coupled together by a bus or other link, although other numbers and types of each of the components and other configurations and locations for the components can be used. The processor in the content management system 12 executes a program of stored instructions for one or more aspects of the present invention as described herein. The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used. The interface system in the content management system 12 is used to operatively couple and communicate between the content management system 12 and the mobile communication system 14 over the communications network, although other numbers and types of connections to other devices, systems, and servers could be used.

A communications network 16 comprising wireless communication technology couples the mobile communication system 14 to the content management system 12, although other types, numbers and combinations of communication systems, such as the Internet, a direct connection, a local area network, a wide area network, modems, e-mails, and/or and phone lines, each having their own communications protocols, in other configurations could be used.

The mobile communication system 14 enables a consumer or operator to opt-in and identify a category of previews and a particular preview to view, although other types and numbers of operations could be performed on the mobile communication system 14 as explained in greater detail herein. In this particular embodiment, the mobile communication system 14 is a mobile phone, although other numbers and types of systems and devices which are able to display or output video and audio content, could be used, such as a phone or blackberry iTV, TV, PDA, mobile phone, iPod, or other computing system by way of example only.

The mobile communication system 14 includes a central processing unit (CPU) or processor, a memory, an interface system, a user input system, and a display system which are coupled together by a bus or other link, although the mobile communication system 14 can comprise other numbers and types of components and systems in other configurations. The processor in the mobile communication system 14 executes a program of stored instructions for one or more aspects of the present invention as described and illustrated herein, although the processor could execute other types of programmed instructions. The memory the mobile communication system 14 stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system can be used for the memory. The interface system in the mobile communication system 14 is used to operatively couple and communicate between the mobile communication system 14 and a content management system 12 over the communications network 16, although other numbers and types of connections to other devices, systems, and servers could be used.

The user input device in the mobile communication system 14 is used to input data, such as detailed information related to the consumer, such as a phone number, date of birth, gender, and billing zip code, although other types of data and information could be entered. The user input device comprises a numerical keypad, although other types and numbers of user input devices can be used. The display system in the mobile communication system 14 is used to show data and information to the consumer, such as the movie, television, and video game previews or content which may include commercials or other customized content. The display system comprises a display screen, such as a LCD screen by way of example only, and a speaker system to provide audio, although other types and numbers of displays could be used.

Although an example of embodiments of the mobile communication system 14 and content management system 12 are described and illustrated herein, each could be implemented on any suitable device, system, or server. It is to be understood that the devices, systems, and servers of the exemplary embodiments are for exemplary purposes, as many variations of the specific hardware and software used to implement the exemplary embodiments are possible, as will be appreciated by those skilled in the relevant art(s).

Furthermore, each of the devices, systems, and servers of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing devices, systems, or servers can be substituted for any one of the devices, systems, or servers in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on one or more of any devices, systems or servers that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for personalized advertising as described herein, which when executed by a processor, causes the processor to carry out the steps necessary to implement the methods of the present invention as described and illustrated herein.

A method for providing previews in accordance with embodiments of the present invention will now be described with reference to FIGS. 1-9. Although in this particular example, the processing steps described herein are substantially executed by the content management system 12 as described below, some or all of these steps can be executed by other systems, devices, or components, such as by mobile communication system 14.

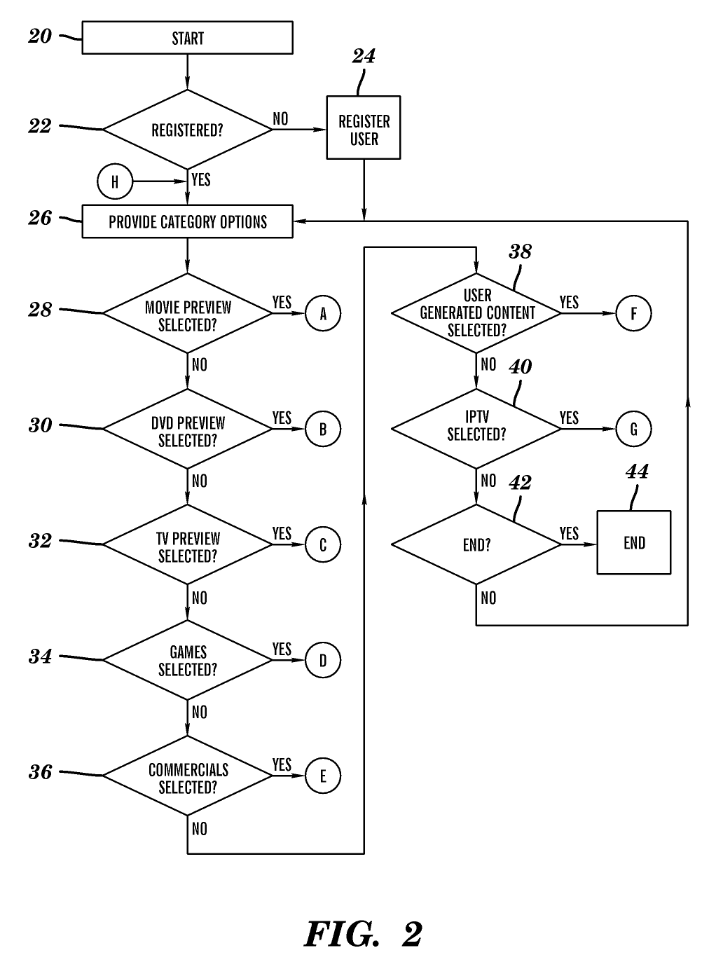

Referring more specifically to FIG. 2, a method for selecting a category of previews to view in accordance with embodiments of the present invention is illustrated. In step 20, the content management system 14 returns a home web page for accessing previews to the mobile communication system 14 in response to a received request, although the previews can be access in other manners over other types of communication media.

In step 22, content management system 14 determines if the operator of the mobile communication system 22 is registered to view previews based on the receipt of or absence of identification information, such as a login name and password by way of example only. If the operator of the mobile communication system 22 is not registered to view previews, then the No branch is taken to step 24. In step 24, the content management system 14 prompts the operator at the mobile communication system 14 for registration information, such as name, address, date of birth, gender, contact information, login name, and password, by way of example only, until the registration process is completed. If the operator of the mobile communication system 22 is already registered to view previews, then the Yes branch is taken to step 26.

In step 26, the content management system 12 provides the mobile communication system 14 with categories of previews, such as movie, DVD, television show, game, commercial, user generated content, and IPTV show previews, for the operator of the mobile communication system 14 to select from, although other numbers and types of categories of previews could be offered.

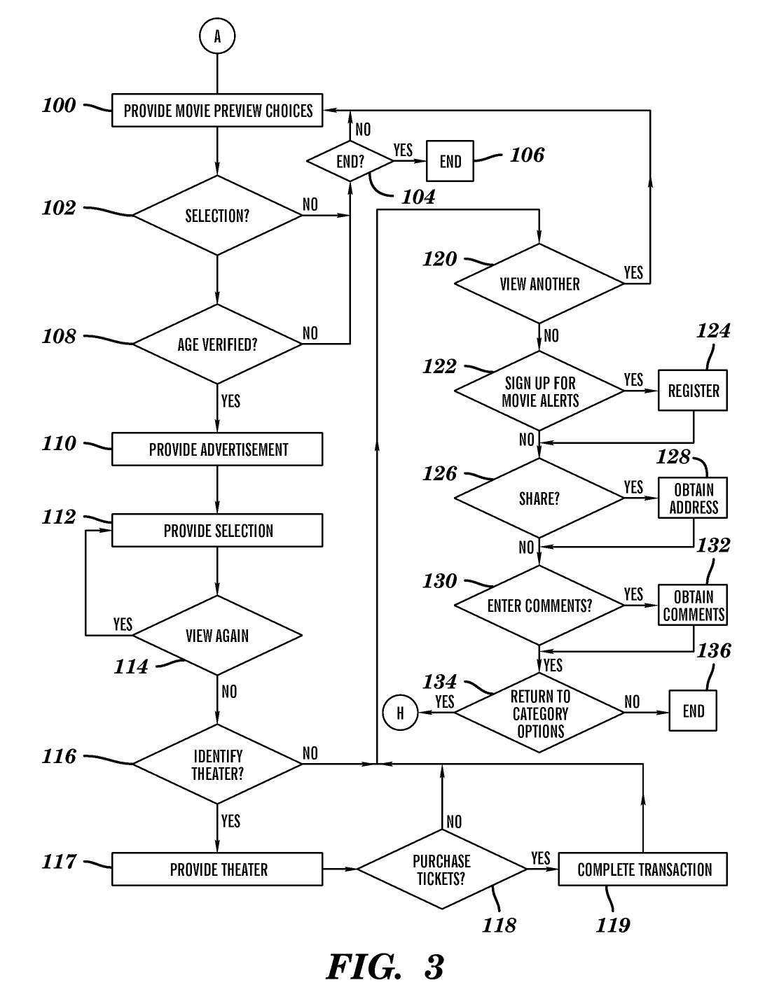

In step 28, the content management system 12 determines if the mobile communication system 14 has selected the category for movie previews. If the content management system 12 determines the mobile communication system 14 has selected the category for movie previews then the Yes branch is taken to step 100 in FIG. 3. If the content management system 12 determines the mobile communication system 14 has not selected the category for movie previews then the No branch is taken to step 30.

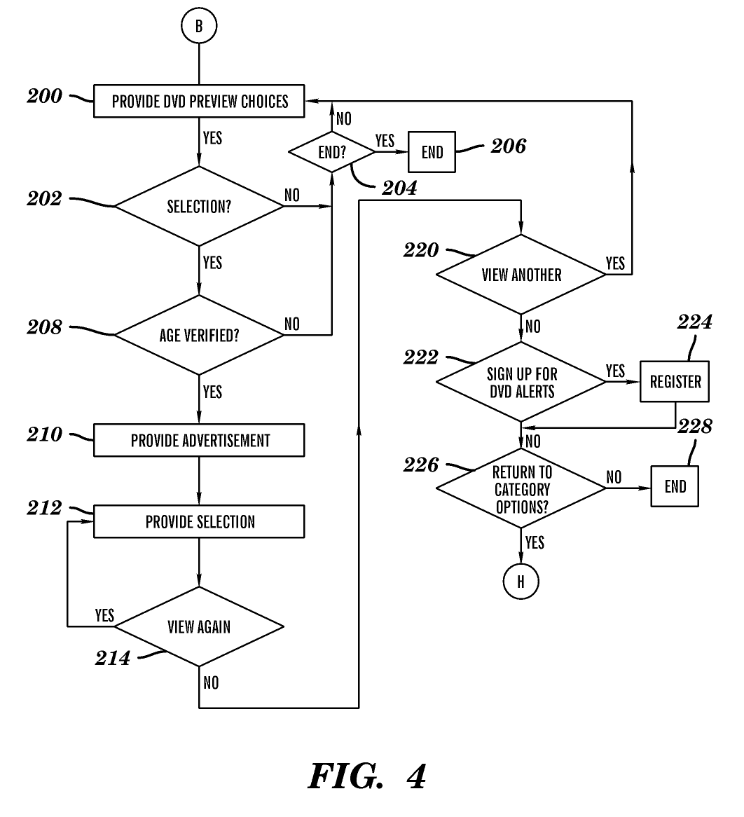

In step 30, the content management system 12 determines if the mobile communication system 14 has selected the category for DVD previews. If the content management system 12 determines the mobile communication system 14 has selected the category for DVD previews then the Yes branch is taken to step 200 in FIG. 4. If the content management system 12 determines the mobile communication system 14 has not selected the category for DVD previews then the No branch is taken to step 32.

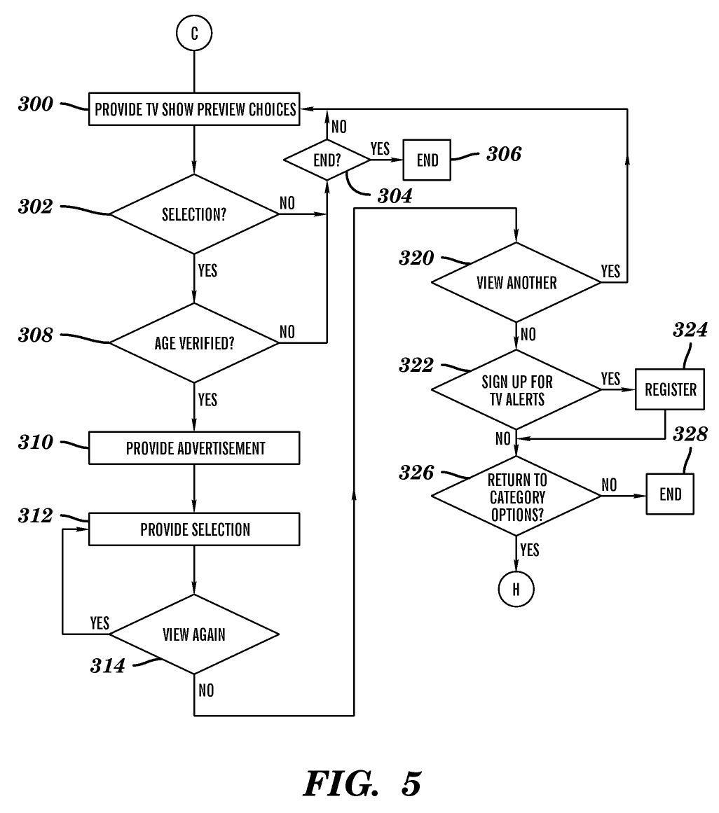

In step 32, the content management system 12 determines if the mobile communication system 14 has selected the category for television show previews. If the content management system 12 determines the mobile communication system 14 has selected the category for television show previews then the Yes branch is taken to step 300 in FIG. 5. If the content management system 12 determines the mobile communication system 14 has not selected the category for television show previews then the No branch is taken to step 34.

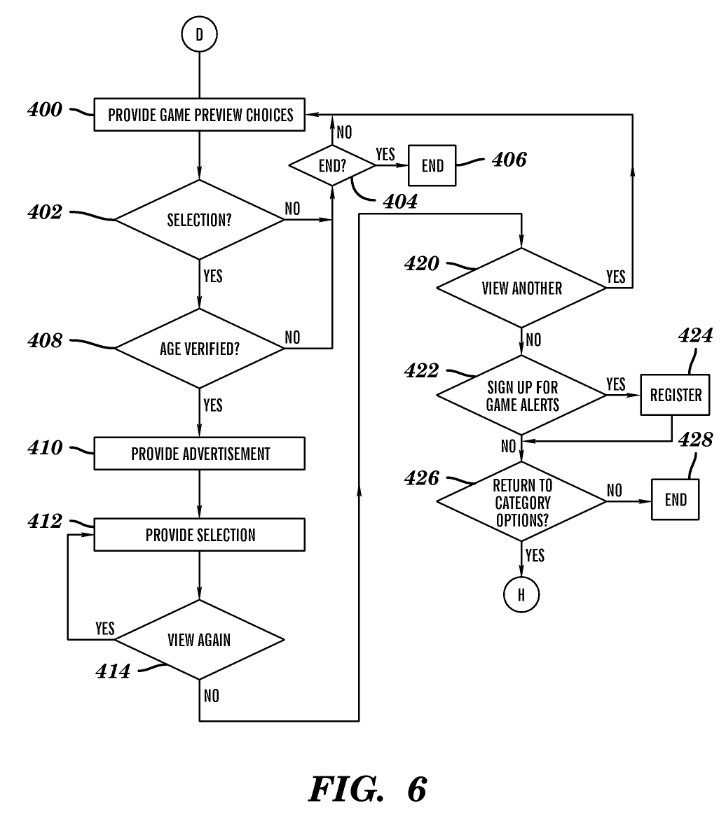

In step 34, the content management system 12 determines if the mobile communication system 14 has selected the category for games previews. If the content management system 12 determines the mobile communication system 14 has selected the category for game previews then the Yes branch is taken to step 400 in FIG. 6. If the content management system 12 determines the mobile communication system 14 has not selected the category for game previews then the No branch is taken to step 36.

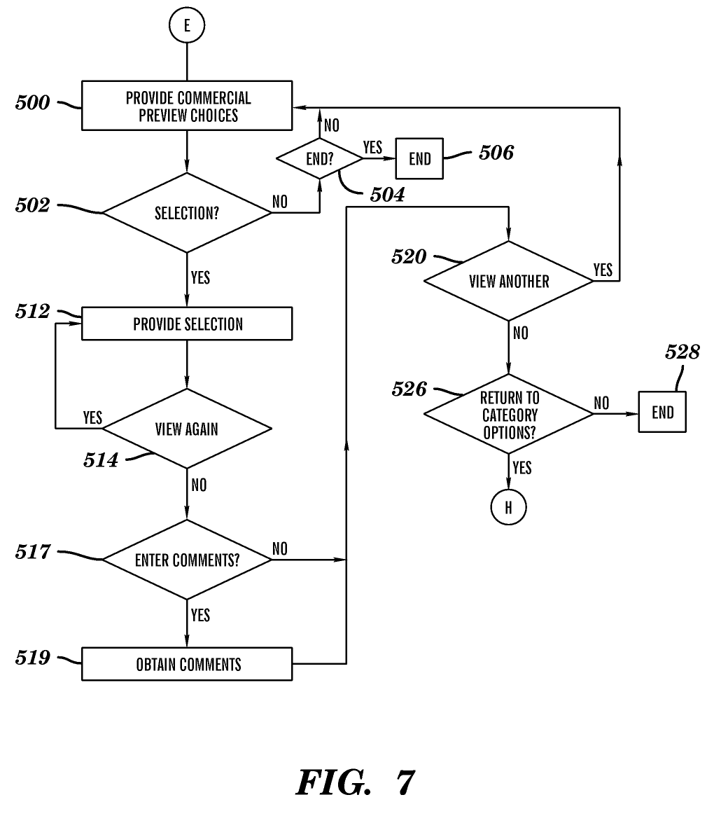

In step 36, the content management system 12 determines if the mobile communication system 14 has selected the category for commercial previews. If the content management system 12 determines the mobile communication system 14 has selected the category for commercial previews then the Yes branch is taken to step 500 in FIG. 7. If the content management system 12 determines the mobile communication system 14 has not selected the category for commercial previews then the No branch is taken to step 38.

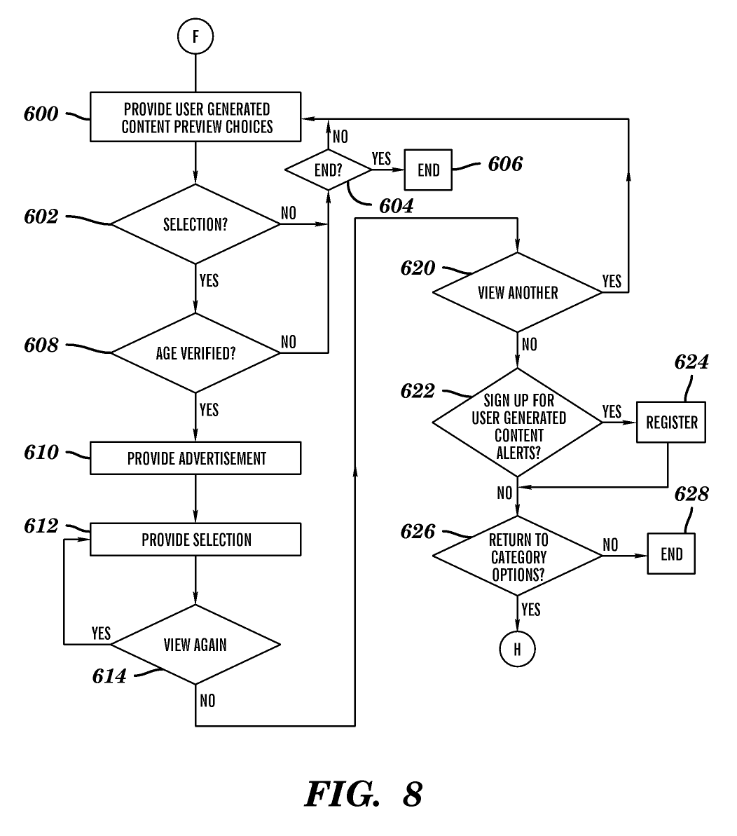

In step 38, the content management system 12 determines if the mobile communication system 14 has selected the category for user generated content previews. If the content management system 12 determines the mobile communication system 14 has selected the category for user generated content previews then the Yes branch is taken to step 600 in FIG. 8. If the content management system 12 determines the mobile communication system 14 has not selected the category for user generated content previews then the No branch is taken to step 40.

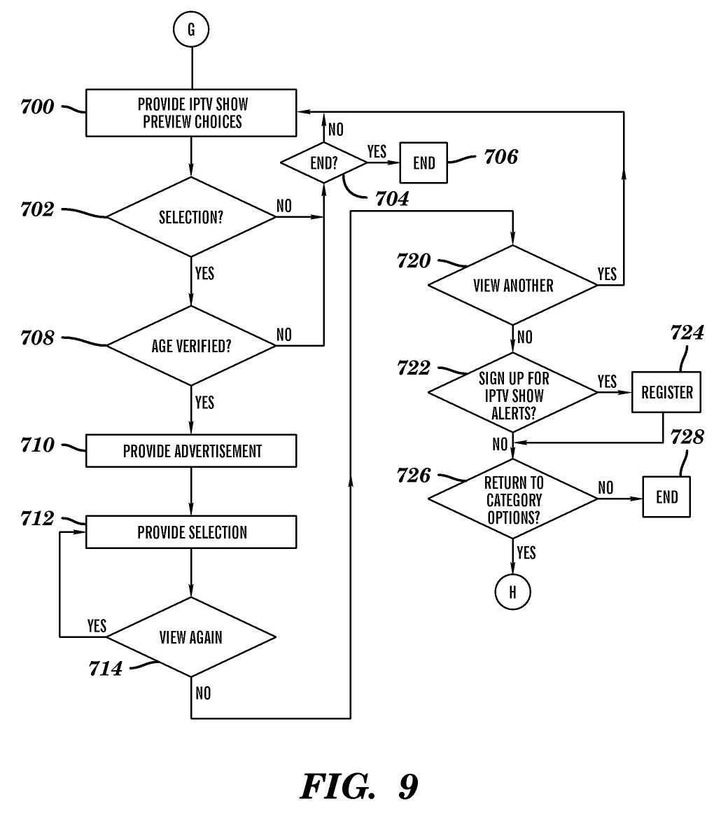

In step 40, the content management system 12 determines if the mobile communication system 14 has selected the category for IPTV show previews. If the content management system 12 determines the mobile communication system 14 has selected the category for IPTV show previews then the Yes branch is taken to step 700 in FIG. 9. If the content management system 12 determines the mobile communication system 14 has not selected the category for IPTV show previews then the No branch is taken to step 42.

In step 42, the content management system 12 determines if either a first period of time has expired without any response from the mobile communication system 12 or a log off indication has been received from the mobile communication system 12, although other types and manners of signing off from the content management system 12 could be used. If the content management system 12 determines that neither a first period of time has expired without any response from the mobile communication system 12 nor a log off indication has been received from the mobile communication system 12, then the No branch is taken back to step 26. If the content management system 12 determines that either a first period of time has expired without any response from the mobile communication system 12 or a log off indication has been received from the mobile communication system 12, then the Yes branch is taken to step 44 where the method ends.

Although the steps for selecting a category of previews is illustrated above in sequence, these steps can be executed in other manners, such as executing two or more of the steps simultaneous or in other orders.

Referring to FIG. 3, in step 100 the content management system 12 provides the mobile communication system 14 with categories of movie previews, such as new releases, in-theaters, drama, comedy, adventure, and horror by way of example only, for the operator of the mobile communication system 14 to select from, although other numbers and types of categories of previews could be offered.

In step 102, the content management system 12 determines if the mobile communication system 14 has selected one of the categories of movie previews. If the content management system 12 determines the mobile communication system 14 has not selected one of the categories for movie previews, then the No branch is taken to step 104.

In step 104, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 100. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 106 where the method ends.

If the content management system 12 determines the mobile communication system 14 has selected one of the category for movie previews based on a received selection, then the Yes branch is taken to step 108. In step 108, the content management system 12 verifies if the age of the operator at the mobile communication system 14 is acceptable to view the selected movie preview based on the date of birth of the operator stored in the registration information, although other manners for verifying the age for viewing the preview can be used and this step is optional. If the age of the operator at the mobile communication system 14 is not verified by the content management system 12 as being acceptable to view the selected movie preview, then the No branch is taken to step 104.

In step 104, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 100. If the content management system 12 determines that a log off indication has been received from the mobile communication system 12, then the Yes branch is taken to step 106 where the method ends.

If in step 108 the age of the operator at the mobile communication system 14 is verified by the content management system 12 as being acceptable to view the selected movie preview, then the Yes branch is taken to step 110. In step 110, the content management system 14 provides an advertisement, such as a pop up advertisement by way of example only, to the mobile communication system 12 before the selected movie preview is provided, although other types and amounts of content could be provided, at other times, and this step is optional.

In step 112, the content management system 14 provides the selected movie preview to the mobile communication system 12, although the mobile preview can be provided from other sources, such as another system or database, in other manners. The mobile communication system 12 receives and displays the selected movie preview in manners well known to those of ordinary skill in the art.

In step 114, the content management system 12 determines if the mobile communication system 14 would like to view the selected movie preview again. If the content management system 12 determines the mobile communication system 14 wants to view the selected movie preview again based on received replay request from the mobile communication system 14, then the Yes branch is taken to step 112 as described earlier. If the content management system 12 determines the mobile communication system 14 does not want to view the selected movie preview again based on either a denial of a replay request from the mobile communication system 14 or the expiration of a second period of time, then the No branch is taken to step 116, although other manners for determining a replay is not desired can be used.

In step 116, the content management system 12 determines if the mobile communication system 14 would like the name and address of any theaters within a set distance of the mobile communication system 12 that currently are playing the movie associated with the movie preview based on a received request for theater information from the mobile communication system 14. If the content management system 12 determines the mobile communication system 14 wants the name and address of any theaters within a set distance of the mobile communication system 12 that currently are playing the movie associated with the movie preview, then the Yes branch is taken to step 117. In step 117, the content management system 12 provides to the mobile communication system 12 the name and address of any theaters within a set distance of the mobile communication system 12 and proceeds to step 118. If the content management system 12 determines the mobile communication system 14 does not wants the name and address of any theaters within a set distance of the mobile communication system 12 that currently are playing the movie associated with the movie preview, then the No branch is taken to step 120.

In step 119, the content management system 12 determines if the mobile communication system 14 would like to purchase one or more tickets to the movie associated with the selected movie preview atone of the identified theaters, although the purchase can be contact in other manners and this step is optional. If the content management system 12 determines the mobile communication system 14 would like to purchase one or more tickets then the Yes branch is taken to step 119 where the content management system 12 prompts and obtains the necessary information to complete the movie ticket purchase transaction. If the content management system 12 determines the mobile communication system 14 does not want to purchase movie tickets, then the No branch is taken to step 120.

Although these purchasing steps are illustrated with reference to movie previews, these purchasing steps also could be incorporated with reference to the viewing of other previews, such as those illustrated and described with reference to FIGS. 4-9. With the immediate purchasing option after viewing a preview, the present invention is able to capture a higher percentage of impulse purchases for products and services, like movies, DVDs, and games.

In step 120, the content management system 12 determines if the mobile communication system 14 would like to view a different movie preview based on a received request to return to the preview menu from the mobile communication system 14. If the content management system 12 determines the mobile communication system 14 wants to view a different movie preview, then the Yes branch is taken to step 100 as described earlier. If the content management system 12 determines the mobile communication system 14 does not want to view a different movie preview, then the No branch is taken to step 122.

In step 122, the content management system 12 determines if the mobile communication system 14 would like to sign up to receive movie alerts, such as information on movie related promotions, games, and news, although this step is optional. If the content management system 12 determines the mobile communication system 14 wants to receive movie alerts, then the Yes branch is taken to step 124 where the content management system 12 prompts and obtains the necessary registration information for the movie alerts from the mobile communication system 14, although this information can be obtained in other manners, such as from stored information about the operator at the mobile communication system. If the content management system 12 determines the mobile communication system 14 does not want to receive movie alerts, then the No branch is taken to step 126.

In step 126, the content management system 12 determines if the mobile communication system 14 would like to sign up to share any of the selected movie previews with operators at other systems, although this step is optional. If the content management system 12 determines the mobile communication system 14 wants to share, then the Yes branch is taken to step 128 where the content management system 12 prompts and obtains the necessary address information for sharing the selected movie previews from the mobile communication system 14, although this information can be obtained in other manners, such as from stored information about the operator at the mobile communication system. If the content management system 12 determines the mobile communication system 14 does not want to share, then the No branch is taken to step 130.

Although these sharing steps are illustrated with reference to movie previews, these sharing steps also could be incorporated with reference to the viewing of other previews, such as those illustrated and described with reference to FIGS. 4-9. With the immediate sharing option after viewing a preview, the present invention is able to quickly direct additional traffic of likely purchasers for products and services, like movies, DVDs, and games, to these previews.

In step 130, the content management system 12 determines if the mobile communication system 14 would like to enter comments about one or more of the selected movie previews. If the content management system 12 determines the mobile communication system 14 wants to enter comments, then the Yes branch is taken to step 132. In step 132, the content management system 12 obtains and stores the comments associated with the selected movie previews from the mobile communication system 12 which can be later be accessed by other systems and devices. If the content management system 12 determines the mobile communication system 14 does not wants to enter comments, then the No branch is taken to step 134.

Although these comment steps are illustrated with reference to movie previews, these sharing steps also could be incorporated with reference to the viewing of other previews, such as those illustrated and described with reference to FIGS. 4-9. Additionally, although obtaining and storing comments is disclose din this example, other manners of obtaining feedback and other information can be used, such as polling, voting, and other survey techniques. With the immediate comment option after viewing a preview, the present invention is able to more quickly capture feedback for products and services, like movies, DVDs, and games, so previews which have limited success can be modified.

In step 134, the content management system 12 determines if the mobile communication system 14 would like to return to the category options for previews. If the content management system 12 determines the mobile communication system 14 does not want to return to the category of options based on a denial of this inquiry, then the No branch is taken to step 136 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 4, in step 200 the content management system 12 provides the mobile communication system 14 with categories of DVD previews, such as new releases, drama, comedy, adventure, and horror by way of example only, for the operator of the mobile communication system 14 to select from, although other numbers and types of categories of previews could be offered.

In step 202, the content management system 12 determines if the mobile communication system 14 has selected one of the categories of DVD previews. If the content management system 12 determines the mobile communication system 14 has not selected one of the categories for DVD previews, then the No branch is taken to step 204.

In step 204, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 200. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 206 where the method ends.

If the content management system 12 determines the mobile communication system 14 has selected one of the category for DVD previews based on a received selection, then the Yes branch is taken to step 208. In step 208, the content management system 12 verifies if the age of the operator at the mobile communication system 14 is acceptable to view the selected DVD preview based on the date of birth of the operator stored in the registration information, although other manners for verifying the age for viewing the preview can be used and this step is optional. If the age of the operator at the mobile communication system 14 is not verified by the content management system 12 as being acceptable to view the selected DVD preview, then the No branch is taken to step 204.

In step 204, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 200. If the content management system 12 determines that a log off indication has been received from the mobile communication system 12, then the Yes branch is taken to step 206 where the method ends.

If in step 208 the age of the operator at the mobile communication system 14 is verified by the content management system 12 as being acceptable to view the selected DVD preview, then the Yes branch is taken to step 210. In step 210, the content management system 14 provides an advertisement, such as a pop up advertisement by way of example only, to the mobile communication system 12 before the selected DVD preview is provided, although other types and amounts of content could be provided, at other times, and this step is optional.

In step 212, the content management system 14 provides the selected DVD preview to the mobile communication system 12, although the mobile preview can be provided from other sources, such as another system or database, in other manners. The mobile communication system 12 receives and displays the selected DVD preview in manners well known to those of ordinary skill in the art.

In step 214, the content management system 12 determines if the mobile communication system 14 would like to view the selected DVD preview again. If the content management system 12 determines the mobile communication system 14 wants to view the selected DVD preview again based on received replay request from the mobile communication system 14, then the Yes branch is taken to step 212 as described earlier. If the content management system 12 determines the mobile communication system 14 does not want to view the selected DVD preview again based on either a denial of a replay request from the mobile communication system 14 or the expiration of a second period of time, then the No branch is taken to step 220, although other manners for determining a replay is not desired can be used.

In step 220, the content management system 12 determines if the mobile communication system 14 would like to view a different DVD preview based on a received request to return to the preview menu from the mobile communication system 14. If the content management system 12 determines the mobile communication system 14 wants to view a different DVD preview, then the Yes branch is taken to step 200 as described earlier. If the content management system 12 determines the mobile communication system 14 does not want to view a different DVD preview, then the No branch is taken to step 222.

In step 222, the content management system 12 determines if the mobile communication system 14 would like to sign up to receive DVD alerts, such as information on DVD related promotions, games, and news, although this step is optional. If the content management system 12 determines the mobile communication system 14 wants to receive DVD alerts, then the Yes branch is taken to step 224 where the content management system 12 prompts and obtains the necessary registration information for the DVD alerts from the mobile communication system 14, although this information can be obtained in other manners, such as from stored information about the operator at the mobile communication system. If the content management system 12 determines the mobile communication system 14 does not want to receive DVD alerts, then the No branch is taken to step 226.

In step 226, the content management system 12 determines if the mobile communication system 14 would like to return to the category options for previews. If the content management system 12 determines the mobile communication system 14 does not want to return to the category of options based on a denial of this inquiry, then the No branch is taken to step 228 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 5, in step 300 the content management system 12 provides the mobile communication system 14 with categories of television show previews, such as news, comedy, sports, and movies by way of example only, for the operator of the mobile communication system 14 to select from, although other numbers and types of categories of previews could be offered.

In step 302, the content management system 12 determines if the mobile communication system 14 has selected one of the categories of television show previews. If the content management system 12 determines the mobile communication system 14 has not selected one of the categories for television show previews, then the No branch is taken to step 304.

In step 304, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 300. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 306 where the method ends.

If the content management system 12 determines the mobile communication system 14 has selected one of the category for television show previews based on a received selection, then the Yes branch is taken to step 308. In step 308, the content management system 12 verifies if the age of the operator at the mobile communication system 14 is acceptable to view the selected television show preview based on the date of birth of the operator stored in the registration information, although other manners for verifying the age for viewing the preview can be used and this step is optional. If the age of the operator at the mobile communication system 14 is not verified by the content management system 12 as being acceptable to view the selected television show preview, then the No branch is taken to step 304.

In step 304, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 300. If the content management system 12 determines that a log off indication has been received from the mobile communication system 12, then the Yes branch is taken to step 306 where the method ends.

If in step 308 the age of the operator at the mobile communication system 14 is verified by the content management system 12 as being acceptable to view the selected television show preview, then the Yes branch is taken to step 310. In step 310, the content management system 14 provides an advertisement, such as a pop up advertisement by way of example only, to the mobile communication system 12 before the selected television show preview is provided, although other types and amounts of content could be provided, at other times, and this step is optional.

In step 312, the content management system 14 provides the selected television show preview to the mobile communication system 12, although the mobile preview can be provided from other sources, such as another system or database, in other manners. The mobile communication system 12 receives and displays the selected television show preview in manners well known to those of ordinary skill in the art.

In step 314, the content management system 12 determines if the mobile communication system 14 would like to view the selected television show preview again. If the content management system 12 determines the mobile communication system 14 wants to view the selected television show preview again based on received replay request from the mobile communication system 14, then the Yes branch is taken to step 312 as described earlier. If the content management system 12 determines the mobile communication system 14 does not want to view the selected television show preview again based on either a denial of a replay request from the mobile communication system 14 or the expiration of a second period of time, then the No branch is taken to step 320, although other manners for determining a replay is not desired can be used.

In step 320, the content management system 12 determines if the mobile communication system 14 would like to view a different television show preview based on a received request to return to the preview menu from the mobile communication system 14. If the content management system 12 determines the mobile communication system 14 wants to view a different television show preview, then the Yes branch is taken to step 300 as described earlier. If the content management system 12 determines the mobile communication system 14 does not want to view a different television show preview, then the No branch is taken to step 322.

In step 322, the content management system 12 determines if the mobile communication system 14 would like to sign up to receive television show alerts, such as information on television show related promotions, games, and news, although this step is optional. If the content management system 12 determines the mobile communication system 14 wants to receive television show alerts, then the Yes branch is taken to step 324 where the content management system 12 prompts and obtains the necessary registration information for the television show alerts from the mobile communication system 14, although this information can be obtained in other manners, such as from stored information about the operator at the mobile communication system. If the content management system 12 determines the mobile communication system 14 does not want to receive television show alerts, then the No branch is taken to step 326.

In step 326, the content management system 12 determines if the mobile communication system 14 would like to return to the category options for previews. If the content management system 12 determines the mobile communication system 14 does not want to return to the category of options based on a denial of this inquiry, then the No branch is taken to step 328 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 6, in step 400 the content management system 12 provides the mobile communication system 14 with categories of game previews, such as educational, fantasy, and sports by way of example only, for the operator of the mobile communication system 14 to select from, although other numbers and types of categories of previews could be offered.

In step 402, the content management system 12 determines if the mobile communication system 14 has selected one of the categories of game previews. If the content management system 12 determines the mobile communication system 14 has not selected one of the categories for game previews, then the No branch is taken to step 404.

In step 404, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 400. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 406 where the method ends.

If the content management system 12 determines the mobile communication system 14 has selected one of the category for game previews based on a received selection, then the Yes branch is taken to step 408. In step 408, the content management system 12 verifies if the age of the operator at the mobile communication system 14 is acceptable to view the selected game preview based on the date of birth of the operator stored in the registration information, although other manners for verifying the age for viewing the preview can be used and this step is optional. By way of example only, an operator must be 13 or older to view a T-rated game preview and 17 or older to view an M-rated game preview. If the age of the operator at the mobile communication system 14 is not verified by the content management system 12 as being acceptable to view the selected game preview, then the No branch is taken to step 404.

In step 404, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 300. If the content management system 12 determines that a log off indication has been received from the mobile communication system 12, then the Yes branch is taken to step 406 where the method ends.

If in step 408 the age of the operator at the mobile communication system 14 is verified by the content management system 12 as being acceptable to view the selected game preview, then the Yes branch is taken to step 410. In step 410, the content management system 14 provides an advertisement, such as a pop up advertisement by way of example only, to the mobile communication system 12 before the selected game preview is provided, although other types and amounts of content could be provided, at other times, and this step is optional.

In step 412, the content management system 14 provides the selected game preview to the mobile communication system 12, although the mobile preview can be provided from other sources, such as another system or database, in other manners. The mobile communication system 12 receives and displays the selected game preview in manners well known to those of ordinary skill in the art.

In step 414, the content management system 12 determines if the mobile communication system 14 would like to view the selected game preview again. If the content management system 12 determines the mobile communication system 14 wants to view the selected game preview again based on received replay request from the mobile communication system 14, then the Yes branch is taken to step 412 as described earlier. If the content management system 12 determines the mobile communication system 14 does not want to view the selected game preview again based on either a denial of a replay request from the mobile communication system 14 or the expiration of a second period of time, then the No branch is taken to step 420, although other manners for determining a replay is not desired can be used.

In step 420, the content management system 12 determines if the mobile communication system 14 would like to view a different game preview based on a received request to return to the preview menu from the mobile communication system 14. If the content management system 12 determines the mobile communication system 14 wants to view a different game preview, then the Yes branch is taken to step 400 as described earlier. If the content management system 12 determines the mobile communication system 14 does not want to view a different game preview, then the No branch is taken to step 422.

In step 422, the content management system 12 determines if the mobile communication system 14 would like to sign up to receive game alerts, such as information on game related promotions, games, and news, although this step is optional. If the content management system 12 determines the mobile communication system 14 wants to receive game alerts, then the Yes branch is taken to step 424 where the content management system 12 prompts and obtains the necessary registration information for the game alerts from the mobile communication system 14, although this information can be obtained in other manners, such as from stored information about the operator at the mobile communication system. If the content management system 12 determines the mobile communication system 14 does not want to receive game alerts, then the No branch is taken to step 426.

In step 426, the content management system 12 determines if the mobile communication system 14 would like to return to the category options for previews. If the content management system 12 determines the mobile communication system 14 does not want to return to the category of options based on a denial of this inquiry, then the No branch is taken to step 428 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 7, in step 500 the content management system 12 provides the mobile communication system 14 with categories of commercial previews, such the latest automobiles, travel destinations, and fashion by way of example only, for the operator of the mobile communication system 14 to select from, although other numbers and types of categories of previews could be offered.

In step 502, the content management system 12 determines if the mobile communication system 14 has selected one of the categories of commercial previews. If the content management system 12 determines the mobile communication system 14 has not selected one of the categories for commercial previews, then the No branch is taken to step 504.

In step 504, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 500. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 506 where the method ends.

If the content management system 12 determines the mobile communication system 14 has selected one of the category for commercial previews based on a received selection, then the Yes branch is taken to step 512.

In step 512, the content management system 14 provides the selected commercial preview to the mobile communication system 12, although the mobile preview can be provided from other sources, such as another system or database, in other manners. The mobile communication system 12 receives and displays the selected commercial preview in manners well known to those of ordinary skill in the art.

In step 514, the content management system 12 determines if the mobile communication system 14 would like to view the selected commercial preview again. If the content management system 12 determines the mobile communication system 14 wants to view the selected commercial preview again based on received replay request from the mobile communication system 14, then the Yes branch is taken to step 512 as described earlier. If the content management system 12 determines the mobile communication system 14 does not want to view the selected commercial preview again based on either a denial of a replay request from the mobile communication system 14 or the expiration of a second period of time, then the No branch is taken to step 517, although other manners for determining a replay is not desired can be used.

In step 517, the content management system 12 determines if the mobile communication system 14 would like to enter comments about the commercial preview. If the content management system 12 determines the mobile communication system 14 wants to enter comments about the commercial preview, then the Yes branch is taken to step 519. In step 519, the content management system 12 receives and stores the comments from the mobile communication system 12 which can be accessed by the mobile communication system 12 and other systems and devices. If the content management system 12 determines the mobile communication system 14 does not wants to enter comments, then the No branch is taken to step 520.

In step 520, the content management system 12 determines if the mobile communication system 14 would like to view a different commercial preview based on a received request to return to the preview menu from the mobile communication system 14. If the content management system 12 determines the mobile communication system 14 wants to view a different commercial preview, then the Yes branch is taken to step 500 as described earlier. If the content management system 12 determines the mobile communication system 14 does not want to view a different commercial preview, then the No branch is taken to step 526.

In step 526, the content management system 12 determines if the mobile communication system 14 would like to return to the category options for previews. If the content management system 12 determines the mobile communication system 14 does not want to return to the category of options based on a denial of this inquiry, then the No branch is taken to step 528 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 8, in step 600 the content management system 12 provides the mobile communication system 14 with categories of user generated content previews for the operator of the mobile communication system 14 to select from, although other numbers and types of categories of previews could be offered.

In step 602, the content management system 12 determines if the mobile communication system 14 has selected one of the categories of user generated content previews. If the content management system 12 determines the mobile communication system 14 has not selected one of the categories for user generated content previews, then the No branch is taken to step 604.

In step 604, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 600. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 606 where the method ends.

If the content management system 12 determines the mobile communication system 14 has selected one of the categories for user generated content previews based on a received selection, then the Yes branch is taken to step 608. In step 608, the content management system 12 verifies if the age of the operator at the mobile communication system 14 is acceptable to view the selected user generated content preview based on the date of birth of the operator stored in the registration information, although other manners for verifying the age for viewing the preview can be used and this step is optional. If the age of the operator at the mobile communication system 14 is not verified by the content management system 12 as being acceptable to view the selected user generated content preview, then the No branch is taken to step 604.

In step 604, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 600. If the content management system 12 determines that a log off indication has been received from the mobile communication system 12, then the Yes branch is taken to step 606 where the method ends.

If in step 608 the age of the operator at the mobile communication system 14 is verified by the content management system 12 as being acceptable to view the selected user generated content preview, then the Yes branch is taken to step 610. In step 610, the content management system 14 provides an advertisement, such as a pop up advertisement by way of example only, to the mobile communication system 12 before the selected user generated content preview is provided, although other types and amounts of content could be provided, at other times, and this step is optional.

In step 612, the content management system 14 provides the selected user generated content preview to the mobile communication system 12, although the mobile preview can be provided from other sources, such as another system or database, in other manners. The mobile communication system 12 receives and displays the selected user generated content preview in manners well known to those of ordinary skill in the art.

In step 614, the content management system 12 determines if the mobile communication system 14 would like to view the selected user generated content preview again. If the content management system 12 determines the mobile communication system 14 wants to view the selected user generated content preview again based on received replay request from the mobile communication system 14, then the Yes branch is taken to step 612 as described earlier. If the content management system 12 determines the mobile communication system 14 does not want to view the selected user generated content preview again based on either a denial of a replay request from the mobile communication system 14 or the expiration of a second period of time, then the No branch is taken to step 620, although other manners for determining a replay is not desired can be used.

In step 620, the content management system 12 determines if the mobile communication system 14 would like to view a different user generated content preview based on a received request to return to the preview menu from the mobile communication system 14. If the content management system 12 determines the mobile communication system 14 wants to view a different user generated content preview, then the Yes branch is taken to step 600 as described earlier. If the content management system 12 determines the mobile communication system 14 does not want to view a different user generated content preview, then the No branch is taken to step 622.

In step 622, the content management system 12 determines if the mobile communication system 14 would like to sign up to receive user generated content alerts, such as information on user generated content related promotions, games, and news, although this step is optional. If the content management system 12 determines the mobile communication system 14 wants to receive user generated content alerts, then the Yes branch is taken to step 624 where the content management system 12 prompts and obtains the necessary registration information for the user generated content alerts from the mobile communication system 14, although this information can be obtained in other manners, such as from stored information about the operator at the mobile communication system. If the content management system 12 determines the mobile communication system 14 does not want to receive user generated content alerts, then the No branch is taken to step 626.

In step 626, the content management system 12 determines if the mobile communication system 14 would like to return to the category options for previews. If the content management system 12 determines the mobile communication system 14 does not want to return to the category of options based on a denial of this inquiry, then the No branch is taken to step 628 where this method ends, although other methods for ending the method can be used. If the content management system 12 determines the mobile communication system 14 does want to return to the category of options based on an acceptance of this inquiry, then the Yes branch is taken back to step 26 in FIG. 2.

Referring to FIG. 9, in step 700 the content management system 12 provides the mobile communication system 14 with categories of IPTV show previews for the operator of the mobile communication system 14 to select from, although other numbers and types of categories of previews could be offered.

In step 702, the content management system 12 determines if the mobile communication system 14 has selected one of the categories of IPTV show previews. If the content management system 12 determines the mobile communication system 14 has not selected one of the categories for IPTV show previews, then the No branch is taken to step 704.

In step 704, the content management system 12 determines if either a first period of time has expired without any response from the mobile communication system 12 or a log off indication has been received from the mobile communication system 12, although other manners of signing off from the content management system 12 could be used. If the content management system 12 determines that neither a first period of time has expired without any response from the mobile communication system 12 nor a log off indication has been received from the mobile communication system 12, then the No branch is taken back to step 700. The first period of time is stored at the content management system 12, although this time period can be stored in other locations and can be adjusted as desired. If the content management system 12 determines that either a first period of time has expired without any response from the mobile communication system 12 or a log off indication has been received from the mobile communication system 12, then the Yes branch is taken to step 706 where the method ends.

If the content management system 12 determines the mobile communication system 14 has selected one of the categories for IPTV show previews based on a received selection, then the Yes branch is taken to step 708. In step 708, the content management system 12 verifies if the age of the operator at the mobile communication system 14 is acceptable to view the selected IPTV show preview based on the date of birth of the operator stored in the registration information, although other manners for verifying the age for viewing the preview can be used and this step is optional. If the age of the operator at the mobile communication system 14 is not verified by the content management system 12 as being acceptable to view the selected IPTV show preview, then the No branch is taken to step 704.

In step 704, the content management system 12 again determines whether a log off indication has been received from the mobile communication system 12 although other types and manners of signing off from the content management system 12 could be used. If the content management system 12 determines that a log off indication has not been received from the mobile communication system 12, then the No branch is taken back to step 600. If the content management system 12 determines that a log off indication has been received from the mobile communication system 12, then the Yes branch is taken to step 706 where the method ends.

If in step 708 the age of the operator at the mobile communication system 14 is verified by the content management system 12 as being acceptable to view the selected IPTV show preview, then the Yes branch is taken to step 710. In step 710, the content management system 14 provides an advertisement, such as a pop up advertisement by way of example only, to the mobile communication system 12 before the selected IPTV show preview is provided, although other types and amounts of content could be provided, at other times, and this step is optional.

In step 712, the content management system 14 provides the selected IPTV show preview to the mobile communication system 12, although the mobile preview can be provided from other sources, such as another system or database, in other manners. The mobile communication system 12 receives and displays the selected IPTV show preview in manners well known to those of ordinary skill in the art.

In step 714, the content management system 12 determines if the mobile communication system 14 would like to view the selected IPTV show preview again. If the content management system 12 determines the mobile communication system 14 wants to view the selected IPTV show preview again based on received replay request from the mobile communication system 14, then the Yes branch is taken to step 612 as described earlier. If the content management system 12 determines the mobile communication system 14 does not want to view the selected IPTV show preview again based on either a denial of a replay request from the mobile communication system 14 or the expiration of a second period of time, then the No branch is taken to step 720, although other manners for determining a replay is not desired can be used.

In step 720, the content management system 12 determines if the mobile communication system 14 would like to view a different IPTV show preview based on a received request to return to the preview menu from the mobile communication system 14. If the content management system 12 determines the mobile communication system 14 wants to view a different IPTV show preview, then the Yes branch is taken to step 700 as described earlier. If the content management system 12 determines the mobile communication system 14 does not want to view a different IPTV show preview, then the No branch is taken to step 722.

In step 722, the content management system 12 determines if the mobile communication system 14 would like to sign up to receive IPTV show alerts, such as information on IPTV show related promotions, games, and news, although this step is optional. If the content management system 12 determines the mobile communication system 14 wants to receive IPTV show alerts, then the Yes branch is taken to step 624 where the content management system 12 prompts and obtains the necessary registration information for the IPTV show alerts from the mobile communication system 14, although this information can be obtained in other manners, such as from stored information about the operator at the mobile communication system. If the content management system 12 determines the mobile communication system 14 does not want to receive IPTV show alerts, then the No branch is taken to step 726.

In step 726, the content management system 12 determines if the mobile communication system 14 would like to return to the category options for previews. If the content management system 12 determines the mobile communication system 14 does not want to return to the category of options based on a denial of this inquiry, then the No branch is taken to step 728 where this method ends, although other methods for ending the method can be used. If the content management system 12 determines the mobile communication system 14 does want to return to the category of options based on an acceptance of this inquiry, then the Yes branch is taken back to step 26 in FIG. 2.

Although the steps for selecting a preview in each of flow charts described above are illustrated in a particular sequence, these steps can be executed in other manners, such as executing two or more of the steps simultaneous or in other orders. Additionally, one or more of the steps in one of the flow charts illustrated and described herein can be incorporated in one or more of the other flow charts. By way of example only, steps 517 and 519 in FIG. 7 can be implemented one or more of the other flow charts described in FIGS. 3-6, 8, and 9.

Accordingly, as illustrated and described by the examples herein the present invention provides an easy to use and effective method and system to preview content, such as for a movie, DVD, TV show, game, commercial, user generated content, and IPTV, whenever and where ever the consumer wants on a mobile communication system

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for providing previews, the method comprising:
providing one or more previews for selection by a mobile communication system;
receiving a selection of one or more of the provided previews from the mobile communication system; and
providing the selected one or more previews for playing to the mobile communication system.

2. The method as set forth in claim 1 further comprising:
providing one or more categories of previews for selection by a mobile communication system; and
receiving a selection of one or more of the provided categories of previews from the mobile communication system, wherein the providing one or more previews is from the one or more selected categories of previews.

3. The method as set forth in claim 1 further comprising obtaining and storing registration information about an operator of the mobile communication system before the receiving of the selection.

4. The method as set forth in claim 3 wherein the registration information comprises name, contact information, and date of birth of the operator.

5. The method as set forth in claim 1 further comprising:
determining a minimum age requirement for the each of the received selections of one or more of the provided previews from the mobile communication system; and
verifying an age of the operator at least meets the minimum age requirement before the providing the selected one or more previews for playing to the mobile communication system.

6. The method as set forth in claim 1 further comprising:
determining when another request to replay the received selection of one or more of the provided previews from the mobile communication system is received; and
providing the selected one or more previews again for playing to the mobile communication system when the determining determines another request to replay has been received.

7. The method as set forth in claim 1 further comprising:
determining when a request to identify one or more locations where a complete version of the received selection of one or more previews can be obtained is received;
identifying the one or more locations; and
providing the identified one or more locations to the mobile communication system.

8. The method as set forth in claim 1 further comprising:
receiving one or more comments from the mobile communication system related to the provided selection of one or more previews for playing to the mobile communication system; and
storing the one or more received comments.

9. The method as set forth in claim 1 further comprising:
determining when a request to select one or more of the other provided previews is received from the mobile communication system; and
providing the one or more previews when the request to select one or more of the other provided previews is determined to be received.

10. The method as set forth in claim 1 further comprising:
determining when a request to receive one or more alerts related to the one or more provided previews is received from the mobile communication system;
registering the mobile communication system to receive the one or more alerts in response to the received request; and
providing the one or more alerts to the registered mobile communication system.

11. A computer readable medium having stored thereon instructions for providing previews comprising machine executable code which when executed by at least one processor, causes the processor to perform steps comprising:
providing one or more previews for selection by a mobile communication system;
receiving a selection of one or more of the provided previews from the mobile communication system; and
providing the selected one or more previews for playing to the mobile communication system.

12. The medium as set forth in claim 11 further comprising:
providing one or more categories of previews for selection by a mobile communication system; and
receiving a selection of one or more of the provided categories of previews from the mobile communication system, wherein the providing one or more previews is from the one or more selected categories of previews.

13. The medium as set forth in claim 11 further comprising obtaining and storing registration information about an operator of the mobile communication system before the receiving of the selection.

14. The medium as set forth in claim 13 wherein the registration information comprises name, contact information, and date of birth of the operator.

15. The medium as set forth in claim 11 further comprising:
determining a minimum age requirement for the each of the received selections of one or more of the provided previews from the mobile communication system; and
verifying an age of the operator at least meets the minimum age requirement before the providing the selected one or more previews for playing to the mobile communication system.

16. The medium as set forth in claim 11 further comprising:
determining when another request to replay the received selection of one or more of the provided previews from the mobile communication system is received; and
providing the selected one or more previews again for playing to the mobile communication system when the determining determines another request to replay has been received.

17. The medium as set forth in claim 11 further comprising:
determining when a request to identify one or more locations where a complete version of the received selection of one or more previews can be obtained is received;
identifying the one or more locations; and
providing the identified one or more locations to the mobile communication system.

18. The medium as set forth in claim 11 further comprising:
receiving one or more comments from the mobile communication system related to the provided selection of one or more previews for playing to the mobile communication system; and
storing the one or more received comments.

19. The medium as set forth in claim 11 further comprising:
determining when a request to select one or more of the other provided previews is received from the mobile communication system; and
providing the one or more previews when the request to select one or more of the other provided previews is determined to be received.

20. The medium as set forth in claim 11 further comprising:
determining when a request to receive one or more alerts related to the one or more provided previews is received from the mobile communication system;
registering the mobile communication system to receive the one or more alerts in response to the received request; and
providing the one or more alerts to the registered mobile communication system.

21. A system for providing previews, the system comprising:
a preview listing system that provides one or more previews for selection by a mobile communication system;
a preview processing system that receives a selection of one or more of the provided previews from the mobile communication system; and
a preview distribution system that provides the selected one or more previews for playing to the mobile communication system.

22. The system as set forth in claim 21 wherein the preview listing system provides one or more categories of previews for selection by a mobile communication system and wherein the preview processing system receives a selection of one or more of the provided categories of previews from the mobile communication system, wherein the preview listing system provides the one or more previews from the one or more selected categories of previews.

23. The system as set forth in claim 21 further comprising a registration system that obtains and stores registration information about an operator of the mobile communication system before the preview processing system receives the selection.

24. The system as set forth in claim 23 wherein the registration information comprises name, contact information, and date of birth of the operator.

25. The system as set forth in claim 21 further comprising an age verification system that determines a minimum age requirement for the each of the received selections of one or more of the provided previews from the mobile communication system, the age verification system verifies that an age of the operator at least meets the minimum age requirement before the preview distribution system provides the selected one or more previews for playing to the mobile communication system.

26. The system as set forth in claim 21 further comprising:
determining when another request to replay the received selection of one or more of the provided previews from the mobile communication system is received; and
providing the selected one or more previews again for playing to the mobile communication system when the determining determines another request to replay has been received.

27. The system as set forth in claim 21 further comprising a source identification system that determines when a request to identify one or more locations where a complete version of the received selection of one or more previews can be obtained is received, the source identification system identifies and provides the identified one or more locations to the mobile communication system.

28. The system as set forth in claim 21 further comprising a comment processing system that receives one or more comments from the mobile communication system related to the provided selection of one or more previews for playing to the mobile communication system and stores the one or more received comments.

29. The system as set forth in claim 21 wherein the preview processing system determines when a request to select one or more of the other provided previews is received from the mobile communication system and wherein the preview listing system provides the one or more previews when the request to select one or more of the other provided previews is determined to be received.

30. The system as set forth in claim 21 further comprising a notification system that determines when a request to receive one or more alerts related to the one or more provided previews is received from the mobile communication system, the notification system registers the mobile communication system to receive the one or more alerts in response to the received request and provides the one or more alerts to the registered mobile communication system.
